(19) United States
(12) Patent Application Publication
(10) Pub. No.: US 2004/0225514 A1
(43) Pub. Date: Nov. 11, 2004

(54) Monetizing a contract to supply a commodity

(76) Inventors: Simon Greenshields, Wilton, CT (US); Michael Kumar, New York, NY (US); Sadek Wahba, New York, NY (US)

Correspondence Address: KIRKPATRICK & LOCKHART LLP, 535 SMITHFIELD STREET, PITTSBURGH, PA, 15222, US

(21) Appl. No.: 10/672,448

(22) Filed: Sep. 26, 2003

(51) Int. Cl. G06F 17/60

(52) U.S. Cl. 705/1

(57) ABSTRACT

A method of monetizing a contract to supply a commodity from a supplier to a recipient is disclosed. According to one embodiment, the method includes transferring the contract to a first entity and revising the contract such that the first entity may provide the commodity to the recipient from sources other than specified in the contract. The method further includes establishing a second contract to supply the commodity from the second entity to the first entity, wherein the price of the commodity in the second contract is less than the price of the commodity in the revised first contract. In addition, the method includes guaranteeing, by a third-party guarantor, payment obligations of the first entity to the recipient arising out of the revised first contract and/or payment obligations of the second entity to the first entity arising out of the second contract. Additionally, the method includes offering debt securities from the first entity and paying, from the first entity to the supplier, proceeds from the offering for transfer of the contract to the first entity. Further, the method may include sufficiently funding a reserve account of the first entity to include funds to cover the debt service on the debt securities for a predetermined time period.

### BACKGROUND OF THE INVENTION

The present invention relates generally to financial transactions and, more particularly, to financial transactions for monetizing a contract to supply a commodity.

Historically, the electric utility industry in the United States was composed primarily of investor-owned utilities, municipal utilities, rural electric cooperatives and various federal power agencies. These entities traditionally have been the only significant providers of electric power to retail and wholesale customers. Further, traditional electric utilities in the United States were vertically-integrated businesses that owned generation, transmission and distribution facilities and whose operations were comprehensively regulated by federal and state governments using a cost-of-service framework. For many investor-owned utilities, the generation of electricity traditionally has been dominant in terms of assets employed, capital invested and revenue generated. However, the structure and operation of the electric industry is changing as a result of increasing competition and changing regulation.

Electric utilities historically have been highly regulated by both state public utility commissions and the Federal Energy Regulatory Commission (“FERC”). State regulatory authorities traditionally exercised their jurisdiction over almost all aspects of utility retail operations. FERC regulates wholesale sales of electric power and the transmission of electricity in interstate commerce pursuant to the Federal Power Act (“FPA”) and regulations promulgated pursuant to its authority under the FPA. FERC also subjects public utilities to rate and tariff regulation and accounting and reporting requirements, as well as oversight of mergers and acquisitions, securities issuances and dispositions of facilities. A power marketer (i.e., a seller of electricity at wholesale) is considered a public utility under the FPA and is subject to FERC regulation by virtue of it making wholesale power sales, even if it does not own generation, transmission or distribution facilities.

Under the Public Utility Holding Company Act of 1935 (“PUHCA”), any company that directly or indirectly owns, controls or holds with the power to vote 10% or more of the outstanding voting securities of a “public utility company” is a public utility “holding company” and must register with the Securities and Exchange Commission (“SEC”) unless it is eligible for an exemption or unless an appropriate application is filed with, and an order is granted by, the SEC declaring it not to be a holding company. PUHCA requires registered public utility holding companies to limit their operations to single integrated utility systems and to divest any other operations not functionally related to the operation of the utility system. A registered holding company and its subsidiaries under PUHCA are subject to financial and organizational regulation, including SEC approval of their financing transactions. SEC staff has consistently stated in “no-action” letters that it would not recommend enforcement action under PUHCA against power marketers that do not own physical electric generation, transmission or distribution facilities.

The Energy Policy Act of 1992 (“EP Act”) engendered more competition in the electric industry. The EP Act permitted independent generation companies that sold power exclusively on a wholesale basis and that satisfied other requirements to be eligible for designation as Exempt Wholesale Generators (“EWG”) and thereby avoid becoming subject to PUHCA. As a result of the new market entry facilitated by the EP Act, competition increased among companies selling power to utilities. The EP Act also expanded FERC's authority to increase competition at the wholesale level by granting FERC the authority to require utilities to provide access to their transmission lines, upon request, to specified entities seeking to transmit power to wholesale purchasers.

A major development in the move to a more competitive electric power industry occurred in 1996 when FERC issued Order Nos. 888 and 889, which contained final rules that introduced competitive reforms into the wholesale power market and increased access to the electric power grid. At the core of the rules is a price regulated transmission sector that provides transmission service completely separated or “unbundled” from generation and supply. Under the rules, all wholesale buyers and sellers of power, including the transmission-owning utilities themselves, are required to take transmission service pursuant to the same pro-forma tariff on the same terms and conditions and at the same prices. Order No. 888 required utilities subject to FERC's jurisdiction to provide access across their transmission systems to third parties and allowed them to seek recovery, as “stranded costs” from the departing wholesale customers of the revenues that the utilities expected to receive from those customers. FERC also imposed certain reciprocity requirements that compel non-jurisdictional utilities (e.g., public power, government owned power marketing administrations or members of the Electric Reliability Council of Texas) to offer the same quality of service as a condition to the eligibility to take advantage of open-access transmission by FERC-regulated utilities. Order No. 888 also required power pools, or associations of interconnected electric transmission and distribution systems that have an agreement for integrated and coordinated operations, to provide open-access transmission. Under Order No. 889, public utilities must provide the public with an electric system for buying and selling transmission service in transactions with the utilities and must abide by specific standards of conduct when using their transmission system to make wholesale sales of power. A federal appeals court upheld Order Nos. 888 and 889 and the United States Supreme Court affirmed that court's decision.

In 1999, FERC issued Order No. 2000, which encouraged transmission-owning utilities to transfer control over their transmission facilities to Regional Transmission Organizations (“RTOs”). FERC's stated objective is to consolidate the nation's multiple utility-owned and operated transmission networks into a relatively small number of RTOs encompassing large regions. Service would be available from the RTO on a uniform and non-discriminatory basis at single rate as compared to having to make multiple requests for service with separate charges from individual transmission providers under the traditional scheme. FERC has already approved RTO arrangements for portions of the U.S. (including the Northeast and Midwest). There are ongoing proceedings that may result in RTOs of the remaining regions at some future time.

To further enhance competition in wholesale electric markets and broaden the benefits and cost savings to all wholesale and retail customers, FERC recently launched several rulemakings to reform public utilities' transmission tariffs and interconnection agreements to reflect a wholesale market design that maximizes competitive transactions. FERC expects that these initiatives will also provide more choices and improved services to all wholesale market participants; reduce delivered wholesale electricity prices through lower transaction costs and wider trade opportunities; improve reliability through better grid operations and expedited infrastructure improvements; and increase certainty about market rules to facilitate investment in much-needed transmission facilities. These proposed rules are pending finalization.

In response to volatility in wholesale electric power and natural gas markets as well as in markets for energy-related financial products, FERC has amended its uniform system of accounting to address financial derivatives and hedging instruments and other financial transactions. FERC has also inquired as to whether it should impose the uniform system of accounting on power marketers as well as traditional public utilities, and whether it should approve securities issuances and assumptions of liability by power marketers on a case-by-case basis rather than by blanket authorization as it currently does. FERC has not taken any final action on these inquires as of this time.

In light of the restructuring initiatives, power marketers have emerged as intermediaries that buy electric energy and/or capacity, ancillary services and other commodities and services from traditional utilities and others and resell these commodities and services at market-based rates in wholesale markets. Unlike traditional utilities, power marketers often own neither generation nor transmission facilities, and have no franchised service area. Wholesale power marketers are subject to FERC jurisdiction under the FPA regarding rates, terms and conditions of service and specified reporting requirements. Because the FPA grants FERC jurisdiction over wholesale electric sales, a power marketer that desires to sell electricity on a wholesale basis must have a tariff accepted for filing by FERC. Wholesale power marketers with tariff rates on file at FERC are considered “public utilities” for the purpose of the FPA. A power marketer may receive FERC authorization to make interstate wholesale power sales at market-based rates if it does not have market power over generation or transmission facilities and does not have other means that would allow it to exercise market power. Power marketers are subject to certain regulatory requirements, such as the filing of quarterly and annual reports with FERC and notifying FERC of any significant change in ownership or affiliation with entities that control generation or transmission. They also must apply for FERC approval of a change in corporate structure or disposition of their jurisdictional assets (e.g., their wholesale tariffs and contracts).

In addition, in 1978, in the midst of an energy crisis that ripped through industrial world economies, Congress passed the Public Utility Regulator Policy Act (“PURPA”). One effect of PURPA was to create a market for power from non-utility power producers. Before PURPA, only utilities could own and operate electric generating plants. PURPA required utilities to buy power from independent companies that could produce power for less than what it would have cost for the utility to generate the power, called the “avoided cost.” The new class of non-utility power producers is commonly referred to as “qualifying facilities” (“QFs”). QFs are typically either small-scale producers of commercial energy who normally self-generate energy for their own needs but may have occasional or frequent surplus energy, or incidental producers who happen to generate usable electric power as a byproduct of other activities. When a facility of this type meets FERC requirements for ownership, size and efficiency, utility companies are obligated under PURPA to purchase energy from these facilities based on an avoided cost pricing structure. These rates tend to be highly favorable to the QF, and are intended to encourage more production of this type of energy as a means of reducing emissions and dependence upon other sources of energy.

In view of PURPA, many power utilities entered into agreements with QFs regarding the purchase and supply of power. Such an agreement is typically referred to as a Power Purchase Agreement (“PPA”). A typical PPA may require the QF to make fixed or minimum electric energy deliveries to the utility over a specified time period for fixed price per quantity of energy (such as MWh). In addition, the PPA typically provides the utility with the right, but not the obligation, to schedule additional electric energy deliveries on a flexible basis up to a specified amount over a specified time period in exchange for a fixed fee (such as a fixed periodic payment), whether or not the utility actually schedules any additional flexible energy deliveries. Thus, payment obligations to the QF under the PPA typically include a fixed portion (for the fixed or minimum deliveries) and a variable portion (for the capacity or flexible deliveries).

Many utilities, however, entered into long-term PPAs with QFs when energy prices were much higher than today. As a result, with the long-term PPAs still in place, many QFs are sell power at higher than market rates. This spread represents a significant source of long-term value to the QF that it must wait for the expiration of the PPA to fully realize. In view of this spread, there is an incentive to monetize the power supply contract in order to accelerate realization of the cost spread.

FIG. 1 is a diagram of one known transaction structured to monetize a power supply contract of a power company 10. Under the original PPA, the power company 10 was required to sell generating capacity and energy from a qualifying facility (QF) 11 that the power company 10 owned to a power utility 12. In order to monetize the PPA, and in order to realize other benefits, such as allowing the power company 10 to no longer maintain the QF 11 as a qualifying facility under PURPA, the power producer formed a special purpose vehicle (SPV) 14 and sold the PPA to the SPV 14 for a purchase price funded by a bond offering to bond holders 16 by the SPV 14. Thus, by selling the PPA to the SPV 14, the SPV 14 took on the obligation of the QF 11 to sell energy and capacity to the utility 12. Further, the PPA was amended to specify that the SPV 14 could meet its capacity and energy obligations to the utility 12 from any source, not just the QF 11 that was obligated to provide the power to the utility 12 under the original PPA. For purposes of this discussion, the revised and amended PPA is referred to as the “revised PPA.” The SPV 14 thus (i) acquired the right, title and interest to the original PPA, and (ii) was required to sell energy and capacity under the revised PPA to the utility 12.

In order to pay the power company 10 for the PPA, the SPV 14 sold bonds in the Rule 144/Reg. S market to the bold holders 16. The proceeds from the bond offering were also used to pay certain transaction costs and to fund a liquidity or reserve account. The interest and principal on the bonds was paid to the bondholders 16 from the capacity and energy payments from the utility 12 under the revised PPA.

In order to meet the SPV's obligations to provide reserve capacity and to deliver energy under the revised PPA, the SPV 14 entered into a mirror PPA with a power marketer 18, effective upon the effective date of the revised PPA. Under the mirror PPA, the power marketer 18 made available to the SPV 14 capacity credits equal to the reserved capacity of the revised PPA, and scheduled and delivered the full amount of the annual energy delivery under the revised PPA to the utility 12 during each year of the revised PPA.

In consideration for the reservation of capacity and delivery of energy by the power marketer 18, the SPV 14 made combined periodic energy and capacity payments to the power marketer 18 under the mirror PPA. The periodic payments to the power marketer 18 under the mirror PPA were to be reduced by a credit to the SPV 14 in the event that (i) the power marketer 18 failed to schedule and deliver the minimum energy deliveries or to deliver energy as scheduled under the revised PPA, (ii) the power marketer did not deliver energy at the utility 12 or at other certain specified locations, or (iii) if the power marketer 18 failed to provide all or part of the reserved capacity to the SPV 14. These credits were calculated in the same manner and applied in the same time frame in which the corresponding credits were applied under the revised PPA. If, at the end of any time period, the amounts of the credits due to the SPV 14 were greater than the total amount that the SPV 14 owed to the power marketer 18 under the mirror PPA for that time period, the power marketer 18 was obligated to pay the SPV 14 in cash the excess portion of those credits.

If the power marketer 18 did not schedule and deliver the annual energy deliveries to the utility 12 in any year, the power marketer 18 was required to pay to the SPV 14 by a scheduled date of the following year an amount equal to the difference between the annual energy deliveries for the preceding year and the energy actually delivered under the mirror PPA in the preceding year multiplied by the difference between the price that the utility 12 paid to the SPV 14 for energy delivered under the revised PPA and the price that the SPV 14 paid to the power marketer 18 under the mirror PPA. In addition to the shortfall payments, the power marketer 18 was also required to pay into a reserve account certain other damages and indemnity payments and distribution surcharges that the SPV 14 may be liable for under the revised PPA.

In addition, in the transaction of FIG. 1, the SPV 14 entered into a services agreement with the power marketer 18 pursuant to which the power marketer 18 agreed to perform all of the SPV's administrative functions, exercise and enforce all of the SPV's rights and perform the SPV's administrative and management obligations or arrange for the performance of all of these obligations, in each case, in accordance with the SPV's material agreements, the indenture and related financing documents.

In addition, the power company 10, which owned 100% of the power marketer 18 in this scenario, entered into a performance guaranty pursuant to which the power company 10 agreed to unconditionally guaranty all obligations (including payment obligations) of the power marketer 18 to the SPV 14 under the mirror PPA and the administrative services agreement, such as for liquidated damages or indemnification payments. Also, the power company 10 entered into an energy funding agreement with the SPV 14, under which the power company 10 was obligated to contribute to the SPV 14 from time to time amounts equal to any additional interest payable by the SPV 14 to the bond holders 16 if there are not sufficient finds in the collections account of the SPV 14 to pay the additional interest due to the bond holder 16.

Payments by the utility 12 under the revised PPA, shortfall payments and excess amounts paid by the power marketer 18 pursuant to the revised PPA or by the power company 10 pursuant to the performance guaranty, amounts in respect of additional interest required by the power company 10 pursuant to the funding agreement, a portion of the proceeds of the bond offering and transfer payments form liquidity account were all to be deposited directly into a reserve account, which a trustee of the SPV 14 was to disburse in order to pay the expenses of the SPV 14. In addition, under certain circumstances, the power marketer 18 was required to pay the SPV 14 certain amounts for damages or indemnity payments that the SPV 14 must make to the utility 12. Those amounts were to be paid into, and the corresponding payment to the utility 12 disbursed from, a collections account. As described before, the power company 10 guaranteed the payments of the power marketer 18.

FIG. 2 is a diagram of another known transaction for monetizing a contract to supply power. The transaction of FIG. 2 is similar to that of FIG. 1 in that, in order to monetize a contract to supply power from the QF 11 to the utility 12, the power company 10 established a SPV 14 and transferred the original PPA from the QF 11 to the SPV 14 and the original PPA was revised in order that the SPV 14 may supply power from other sources besides the QF 11. The transaction of FIG. 2 is different from that of FIG. 1 in that the power company 10 did not guarantee the payment obligations of the power marketer 18 to the SPV 14 for such things as liquidated damages and indemnity payments under the mirror PPA, but rather a third-party guarantor 20 guaranteed such payment obligations of the power marketer 18. This may be desirable for the bondholders 16 where the third-party guarantor 20 has a better credit rating than the power company 10.

In addition, the transaction of FIG. 2 is different from that of FIG. 1 in that the SPV 14 also established an administrative services agreement with an administrative agent 22. Pursuant to the administrative services agreement, the administrative agent 22, in consideration for payment for services from the SPV 14, agreed to (i) administer and perform all of the SPV's 14 managerial and administrative obligations under the revised PPA, (ii) exercise all of the SPV's rights under the mirror PPA, (iii) coordinate the SPV's 14 operations under both agreements, (iv) administer and perform all of the SPV's 14 managerial and administrative obligations under other material agreements of the SPV 14, and (v) notify the power marketer 18 and the third-party guarantor 20 of its payment obligation under the mirror PPA and the third-party guaranty.

### SUMMARY OF THE INVENTION

In one general respect, embodiments of the present invention are directed to a method of monetizing a contract to supply a commodity from a supplier to a recipient. According to one embodiment, the method includes transferring the first contract to a first entity and revising the first contract such that the first entity may provide the commodity to the recipient from sources other than specified in the first contract. The method may further include establishing a second contract to supply the commodity from the second entity to the first entity, wherein the price of the commodity in the second contract is less than the price of the commodity in the revised first contract. In addition, the method may include guaranteeing, by a third-party guarantor, payment obligations of the first entity to the recipient arising out of the revised first contract.

According to other variations, the method may include offering debt securities (e.g., notes or bonds) from the first entity and paying, from the first entity to the supplier, proceeds from the offering. In addition, the method may include sufficiently funding a reserve account of the first entity such that the first entity can pay the principal and interest on the debt securities in the event of a force majeure of at least six months. Further, the method may include the third-party guarantor guarantying payment obligations of the second entity to the first entity arising out of the second contract. Additionally, the method may include revising the first contract to obligate the recipient to pay a fixed price for to the first entity for capacity to supply the commodity and obligates the recipient to pay an index-based price for the commodity.

In another general respect, embodiments of the present invention are directed to a method of monetizing a first contract to supply power from a qualifying facility owned by a first power company to a power distributor. According to one embodiment, the method may include transferring the first contract from the power company to a first business entity and revising the first contract such that the first business entity may provide power to the power distributor from sources other than the QF. In addition, the method may include establishing a second contract to supply power between a power supplier and the first business entity, wherein the quantity and capacity terms of the second contract are similar to the revised first contract. Additionally, the method may include guaranteeing, by a third-party guarantor, performance obligations of the of the first business entity to the power distributor arising out of the revised first contract.

In addition, according to various embodiments, the method may include the third-party guarantor guarantying payment obligations of the power supplier to the first entity arising out of the second contract. Additionally, the method may include revising the first contract to obligate the power distributor to pay a fixed price for to the first entity for capacity to supply the power and obligates the power distributor to pay an index-based price for the power.

According to various other embodiments, the first business entity, i.e., that business entity to which the first contract is transferred, may be a special purpose vehicle (“SPV”) owned by the power company. The method may further include the issuance of debt securities by the first business entity and paying, by the first business entity to the power company, for transfer of the first contract from the power company to the first business entity from proceeds from the offering of the debt securities. The method may also include paying to the holders of the debt securities principal and interest on the debt securities. The debt service coverage ratio may be close to 1.00, such as from 1.00 to 1.01. In addition, the method may include sufficiently funding a reserve account of the first entity such that the first entity can pay the principal and interest on the debt securities in the event that the first entity is not receiving payments from the power distributor for a period of time for any reason. The size of the debt service reserve can also be increased by staggering the payments to the first entity from the power distributor.

The power distributor may be a government agency tasked with managing and procuring power for a government, such as a state. For example, the power distributor may be the California Department of Water Resources (“CDWR”). CDWR is a department within the Resource Branch of the Executive Branch of the State of California that was designated to manage the power procurement for all California electric utility plants.

According to various other implementations, the first contract may obligate the power company to supply power from a qualifying facility owned by the power company to a power distributor and allow the power distributor to terminate the first contract if less than a threshold amount of the required power under the first contract is not supplied within a specified time frame. In this case, the method may include establishing a second contract to supply power between a power supplier and the first business entity, wherein the second contract obligates the power supplier to pay liquidated damages when the threshold amount of required power is not supplied by the power supplier over the specified time frame.

Where the original contract to supply power lacks force majeure makeup provisions, the method, according to various embodiments, may sufficiently funding a reserve account of the first business entity to include funds to cover the debt service on the debt securities for a predetermined time period, such as six months.

According to other embodiments, the method may include revising the first contract that the power distributor is obligated to pay the first business entity an index-based price plus a margin for power supplied under the revised first contract to the power distributor and monetizing the margin.

Embodiments of the present invention provide benefits over known contract monetization transactions. These advantages, in various embodiments, include reduced risk for the bondholders by, for example, lowering the debt service coverage ratio and establishing a sufficiently funded reserve account to withstand a prolonged force majeure. In addition, embodiments of the present invention take into account complicated regulatory issues associated with a power distributor that is a government agency tasked with managing the power procurement needs of a state. These and other benefits will be apparent from the description to follow.

### DESCRIPTION OF THE FIGURES

Embodiments of the present invention are described herein with reference to the examples depicted in the following figures, wherein:

FIGS. 1 and 2 are diagrams of known transaction to monetize a contract to supply power;

FIG. 3 is a diagram of a method to monetize a contract according to embodiments of the present invention;

FIG. 4 is a flowchart depicting embodiments of the method to monetize the contract;

FIG. 5 is a diagram of a system that may be used in practicing the method according to various embodiments; and

FIG. 6 is a diagram of a system according to various embodiments of the present invention.

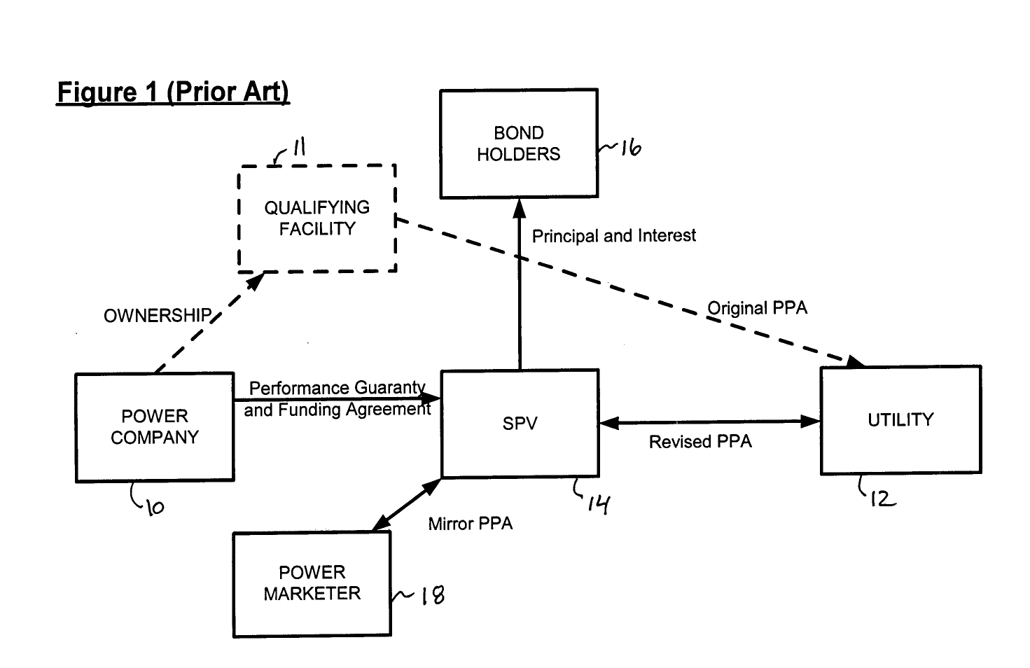

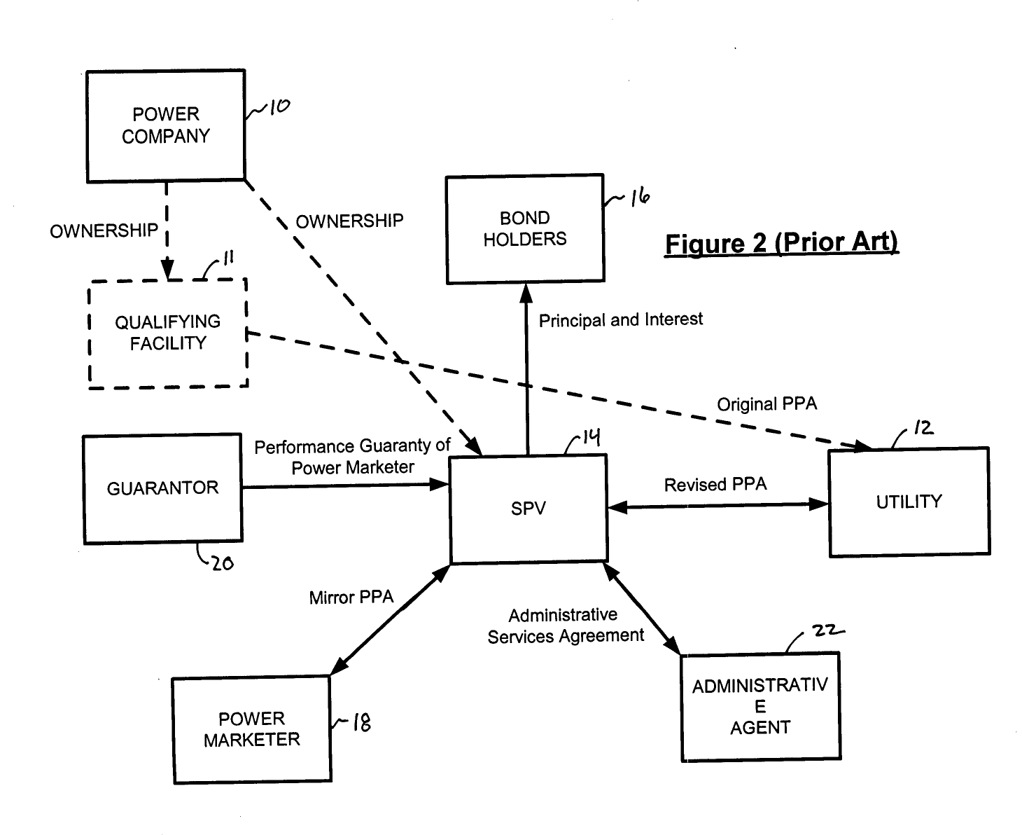

### DESCRIPTION OF THE INVENTION

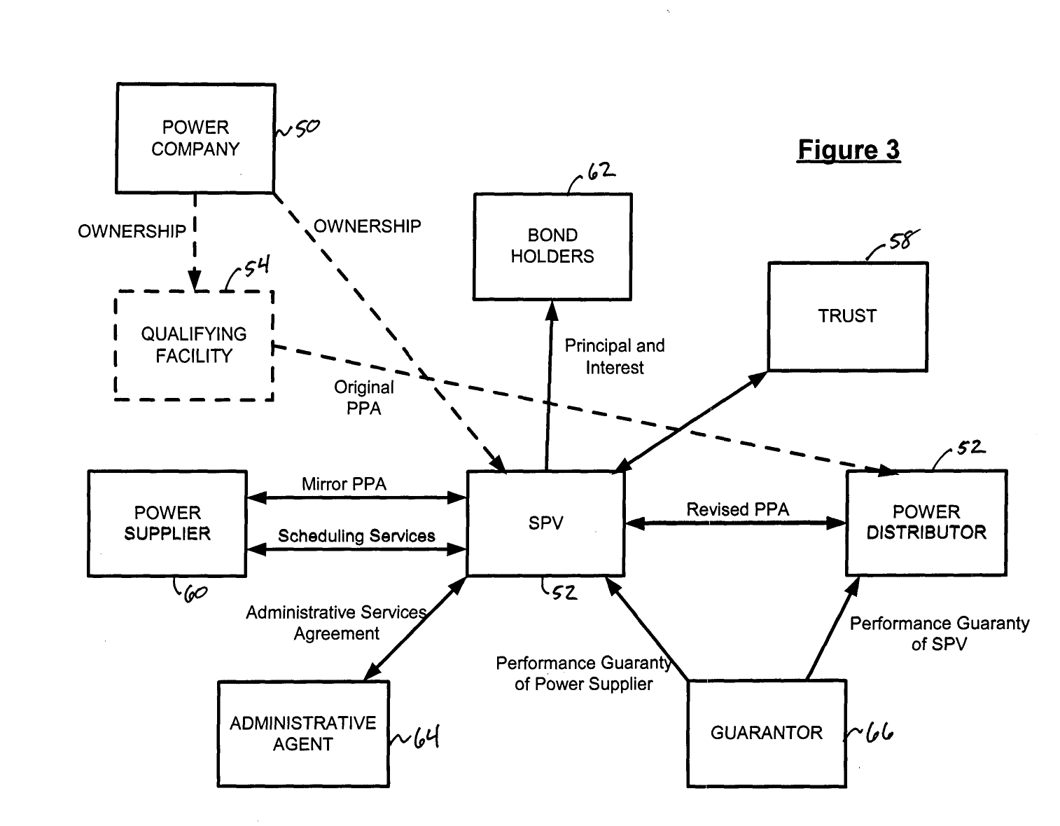

FIG. 3 is a diagram of a financial transaction according to various embodiments of the present invention. The purpose of the transaction of FIG. 3, according to one embodiment, is to monetize a contract between the power company 50 and the power distributor 52 whereby the power company 50 is obligated to supply power, e.g., electrical power and/or energy capacity, to the power distributor 52. According to one embodiment, the contract may obligate the power company 50 to supply energy and/or capacity to the power distributor 52 from a qualifying facility (“QF”) 54 under PURPA that may be owned, wholly or partially, by the power company 50.

The contract, which may be referred to as the “original PPA,” may obligate the power company 50 to supply to the power distributor 52 from the QF 54 fixed or minimum electric energy deliveries over a specified time period for fixed price per quantity of energy (such as MWh). In addition, the PPA may require the QF 54 to provide energy capacity to the power distributor 52, for example, by providing the power distributor with the right, but not the obligation, to schedule additional electric energy deliveries on a flexible basis up to a specified amount over a specified time period in exchange for a fixed fee (such as a fixed periodic payment), whether or not the utility actually schedules any additional flexible energy deliveries. For example, the PPA may require the QF 54 to provide a fixed delivery of energy in each hour for the term of the PPA to the power distributor 52 for a fixed price per unit energy (e.g., MWh) and to schedule additional electric energy deliveries on a flexible basis of up to a specified amount per hour for the term of the PPA in exchange for a fixed price (such as a fixed periodic payment during the term of the PPA), whether or not the additional energy deliveries are made. These additional, flexible energy deliveries are sometimes referred to herein as “energy capacity.”

In order to monetize the contract, the power company 50 may establish a subsidiary business entity 56. The subsidiary business entity 56, which may be wholly or partially owned by the power company 50, may be, for example, a special purpose vehicle (“SPV”). In that connection, for purposes of convenience only, the business entity 56 is referred to hereinafter, and in FIG. 3, as an SPV. The SPV is a business interest formed solely in order to accomplish some specific task or tasks. In this case, the specific tasks to be formed by the SPV 56, as will be apparent from the description to follow, include providing energy and energy capacity under a revised PPA to the power distributor 52. For example, the power company 50 may transfer (e.g., sell) the original PPA to the SPV 56. The original PPA may then be amended to state that the SPV 56 may supply the energy and energy capacity from any source, not just the QF 54. Other terms of the original PPA, such as the price for energy and energy capacity, the delivery schedules, and the term of the contract, may remain unaffected. For purposes of convenience in the description to follow, therefore, the contract to supply energy and energy capacity from the SPV 56 to the energy distributor 52 is referred to as the “revised PPA.” Thus, under the revised PPA, the SPV 56, and not the power company 50, is contractually obligated to supply energy and energy capacity to the power distributor 52 and the power distributor 52 is required to pay the SPV 56 for such energy and energy capacity.

The SPV 56 may have no assets other than the revised PPA. In addition, the SPV 56 may be bankruptcy-remote from the power company 50. That is, the SPV 56 may be organized such that its assets and liabilities are not consolidated with the power company 50 if the power supplier enters bankruptcy. In turn, the power company 50 may assume no liability towards the SPV 56. In order to achieve this, according to one embodiment, the SPV 56 may be administered and managed by an independent trust 58, to be described further below.

In order to obtain the energy and energy capacity the SPV 56 needs to supply to the power distributor 52, the SPV 56 may then enter into another contract, referred to herein as the “mirror PPA,” with a power supplier 60 that is a separate business entity capable of supplying electrical power, such as a power marketer. Terms of the mirror PPA may match terms of the revised PPA with respect to, for example, the quantity of energy and energy capacity, the delivery schedules, the term of the contract and penalties for breach. Under the mirror PPA, however, the power supplier 60 is contractually obligated to provide energy and energy capacity to the SPV 56 (which the SPV 56 may pass on to the power distributor 52 under the revised PPA) and the SPV 56 is required to pay the power supplier 60 for such energy and energy capacity (which the SPV 56 may pay with revenue from the revised PPA). Both the revised PPA and the mirror PPA may be of the same duration and stipulate the same amounts of energy and energy capacity to be delivered. The price at which the SPV 56 buys the energy and energy capacity from the power supplier 60 under the mirror PPA may be lower than that at which the SPV 56 is paid by the power distributor 52 for the same energy and energy capacity under the revised PPA.

Under the mirror PPA, the power supplier 60 effectively becomes the entity that must obtain or produce the power to be delivered to the power distributor 52. If the power supplier 60 fails to deliver the necessary power, then the SPV 56 would be unable to fulfill its obligations to the power distributor 52 and would, for example, have to pay damages (e.g., termination or liquidated damages), as specified in the revised PPA, to the power distributor 52. In turn, the power supplier 60 would then have to pay damages to the SPV 56, as specified in the mirror PPA. Since the revised and mirror PPA may have identical terms with respect to penalties for breach, such as damages, ultimately the power supplier 60 may be effectively liable to the power distributor 52 if the SPV 56 breaches the revised PPA. In that connection, to make the bond offering, described in more detail below, more attractive to the bond holders 62, the power supplier 60 may need to demonstrate the ability to supply the necessary power under the mirror PPA and otherwise be able to satisfy the terms of the mirror PPA.

In every period of the revised PPA the SPV 56 may receive cash from the power distributor 52 that is deposited into a collections account managed by the trust 58. The SPV 56 may pay the power supplier 60 for the energy and energy capacity received from the power supplier 60 with proceeds from the collections account. Due to the difference in price, i.e., the spread between the price that the SPV 56 supplies power to the power distributor 52 and the price at which the SPV 56 acquires power from the power supplier 60, the collections account may have excess cash left over in every period of the revised PPA.

In order to raise the capital to pay for the transfer of the original PPA from the power company 50 to the SPV 56, the SPV 56 may issue, for example, debt securities to investors. The debt securities may be, for example, bonds or notes. For example, the SPV 56 may offer senior secured debt securities to bond holders 62 in, for example, the Rule 144A/Reg. S market. The term of the debt securities may equal the term of the revised and mirror PPAs. The debt service for the debt securities may be financed by the excess cash that the collections account of the SPV 56 has left over after every period of the revised PPA (arising out of the above-described price difference between the revised PPA and the mirror PPA).

According to other embodiments, the SPV 56 may offer subordinated debt to the bondholders 62 as well. The subordinated debt may be subordinate to senior debt issued by the SPV 56. The subordinate notes may have equity-like characteristics. For example, an event of default on the subordinated debt need not cause a default of the senior notes. The subordinated debt may also have some of the characteristics of the senior debt. For example, the subordinated notes may include a reserve account which could allow it to also be rated by rating agencies. In addition, according to other embodiments, the SPV 56 may issue equities to investors to raise the capital to pay the power company 50 for the PPA.

The trust 58 may oversee the transfer of power from the power supplier 60 to the power distributor 52. Alternatively, an administrative agent 64, to be described in more detail below, may perform this function. In addition, the trust 58 may receive the revenues from the power distributor 52, pay the power supplier 60 and pay the principal and interest to the bondholders 62. Proceeds from the offering of the debt securities to the bondholders 62 (less expenses and deductions, such as for a reserve account, described further below) may be passed on to the power company 50 for transfer of the original PPA.

As shown in FIG. 3, a third-party guarantor 66 may, for example, irrevocably and unconditionally guarantee to the SPV 56 the due and punctual payment of all amounts payable under the mirror PPA by the power supplier 60. This includes, for example, (i) payments to the SPV 56 in the amount required to be paid to the power distributor 52 in the event of the SPV's unexcused failure to deliver the requisite energy or energy capacity under the revised PPA, (ii) payments to the SPV 56 in the amount of distribution surcharges required to be paid to the power distributor 52, and (iii) payments to the SPV 56 in the form of liquidated damages in the event the power supplier 60 fails to deliver the requisite amount of energy. In that connection, according to one embodiment, the power supplier 60 may be a subsidiary of the third-party guarantor 66.

In addition, the third-party guarantor 66 may irrevocably and unconditionally guarantee the payment of all the SPV's payment obligations under the revised PPA to the power distributor 52. This includes any obligation of the SPV 56 to pay damages (e.g., liquidated damages) or make termination or indemnity payments to the power distributor 52 under the revised PPA if the SPV 56 fails to perform any of its obligations of the revised PPA. According to one embodiment, this performance guarantee by the third-party guarantor 66 of the SPV 56 may be capped by a maximum liability limitation amount. The third-party guarantor 66 may have a better credit rating than the power company 50, thereby reducing risk to the bondholders 62 from the risk of termination of the revised PPA by the power distributor 52 as a result of a default by the SPV 56 under the revised PPA caused, for example, by the power supplier's default under the mirror PPA.

Pursuant to the indenture, the trust 58, which may be, for example, a securities intermediary or a bank, may establish the following accounts on behalf of the SPV 56: (1) the collections account; (2) the reserve account; (3) a reserve investment account; (4) a damages and indemnity account; and (5) a working capital account. The trust 58 may have perfected security interests in one or more of the accounts for its benefit and for the benefit of the bondholders 62.

All payments to the SPV 56 by the power distributor 52 pursuant to the revised PPA, all payments by the power supplier 60 pursuant to the mirror PPA, and all payments by the third party guarantor 66 pursuant to the third party guarantor's guaranty of the power supplier's 60 performance (or the SPV's performance), and all transfer payments from the reserve account, may be deposited directly into the collections account. The trust 58 may disperse funds from the collections account to pay the SPV's expenses (including electric energy payments to the power supplier 60) in a specific order of priority. The trustee of the trust 58 may also, for example, pay semi-annually from the collections account the payments of interest and principal due on the debt securities to the bondholders 62.

The reserve account may be funded in an amount equal to the greatest scheduled payment of principal and interest due on the debt securities on a semi-annual payment date (the “reserve required balance”). The purpose of a reserve account may be to provide the trust 58 with sufficient funds to make a principal or interest payments when due on the debt securities if the amount of such payment exceeds the amount then on deposit in the collections account. If funds are withdrawn from the reserve account to make a payment on the debt securities, the reserve account may subsequently be replenished to the reserve required balance with funds from the collections account to the extent available. If funds are not available from the collections account, the reserve required balance would not be maintained. Amounts in excess of the reserve required balance on deposit in the reserve account on any semi-annual payment date may be transferred on the next semi-annual payment date to the collections account. Any interest earned on the reserve account may be deposited and retained in the reserve investments account, and such amounts may not be released without consent from a rating agency.

If either party (the “claiming party”) to the revised PPA (i.e., the SPV 56 or the power distributor 52) is prevented by a force majeure event from performing its obligations under the revised PPA, the claiming party may be excused from performance of its obligations (other than, for example, the obligation to make payments then due or becoming due with respect to performance prior to the force majeure event), provided that the claiming party gives notice and details of the force majeure event to the other party as soon as practicable. The revised PPA may require the claiming party to remedy the force majeure with all reasonable dispatch. In addition, the non-claiming party may not be required to perform or resume performance of its obligations to the claiming party corresponding to the obligations of the claiming party excused by force majeure. Similarly, if either party to the mirror PPA (i.e., the SPV 56 or the power supplier 60) is prevented by a force majeure event from performing its obligations under the mirror PPA, the claiming party may likewise be excused from performance of its obligations under the mirror PPA.

An event of force majeure may be an event or circumstance which prevents one of the parties under the agreements (i.e., the revised PPA or the mirror PPA) from performing its contractual obligations where the event (a) was not reasonably foreseeable as of the date of the transaction, (b) was not within the reasonable control of, or the result of negligence of, the claiming party, and (c) which, by exercise of due diligence, the claiming party is unable to overcome or avoid or cause to be avoided. An event of force majeure may include, for example: (i) shortages of materials or supplies; (ii) strikes or labor disruptions; (iii) interruptions of fuel supply, water supply or transmission, damages or breakdown of machinery; (iv) drought, flood, earthquake, storm, fire, lighting, epidemic, war, riot, civil disturbance or sabotage; or (v) inability to obtain and maintain applicable governmental approvals from a governmental authority resulting solely from the enactment, repeal or amendment in any applicable law or in the interruption of application of any applicable law by such governmental authority, in each case occurring after the date of the transaction.

If the SPV 56 is required by the terms of the revised PPA to pay damages, termination or indemnity amounts to the power distributor 52, then the power supplier 60 (and/or the third party guarantor 66 as guarantor of the power supplier's payment obligations) may be required to pay similar amounts pursuant to the mirror PPA. Those amounts, if any, may be paid into, and the corresponding amounts to the power distributor 52 may be paid from, the damages and indemnity account. In addition, if both the revised PPA and the mirror PPA are terminated, and the defaulting party under the mirror PPA is the power supplier 60, any termination payment made by the power supplier 60 may be used to pay the outstanding principal of, and any accrued and unpaid interest on, the debt securities as of the date such termination payment is paid, and to make any required termination payment to the power distributor 52. If the power distributor 52 is required by the terms of the revised PPA to pay damages, termination or indemnity amounts to the SPV 56, those amounts may be paid into, and the corresponding payments to the power supplier 60 may be paid from, the damages and indemnity account.

The SPV 56 may enter into a scheduling services agreement with, for example, the power supplier 60, under which the power supplier 60 will act (i) as the SPV's scheduling coordinator to schedule and coordinate deliveries to the SPV 56 under the mirror PPA and the SPV's deliveries to the power distributor 52 under the revised PPA and (ii) as the SPV's agent for purposes of communicating with the SPV's scheduling coordinator and managing the SPV's obligations to schedule, deliver and receive energy in accordance with the revised PPA and the mirror PPA. The power supplier's responsibilities as the SPV's scheduling agent may also include (i) notifying the SPV 56 of the SPV's payment obligations under the mirror PPA; (ii) notifying the power distributor 52 of its payment obligations under the revised PPA; and (iii) providing the administrative agent 64 and the trust 58 with copies of all such notices on a periodic basis.

The SPV 56 may also enter into an administrative services agreement with the administrative agent 64. According to the administrative services agreement, the administrative agent 64 may administer and perform all of the SPV's administrative obligations under the revised PPA (other than scheduling electrical energy to be delivered to the power distributor 52 and certain related services, which may be the responsibility of the power supplier 60 under the scheduling services agreement), exercise on behalf of the SPV 56 all of the SPV's rights under the mirror PPA and coordinate operations of the SPV 56 under both the revised PPA and the mirror PPA. In addition, the administrative agent 64 may administer and perform all of the SPV's administrative obligations under other material agreements of the SPV 56, the indenture and other financial documents.

With the transaction structure described above, the risk of the bondholders 62 does not originate with the SPV 56 but rather from the power supplier's ability to supply the power and the power distributor's ability to pay the required revenue. According to various embodiments, additional measures may be taken to reduce risk to the bondholders 62.

First, the debt service coverage ratio (“DSCR”) of every period of the revised PPA may be set to a value greater than, but preferably close to, 1 such as, for example, between 1.00 and 1.01. The DSCR is the ratio between the net cash flow in a period (in this case the spread between the selling and cost price) and the debt service (principal and interest on the debt securities) due in each period. This condition would ensure that there is excess cash available to the SPV 56 even after the debt service payments in each period have been made. The excess cash may be used not only to pay the fees of the administrative agent 64, the trustee 58, and/or the scheduling agent (e.g., the power supplier 60), but can also be deposited in the SPV's reserve account instead of being passed onto the parent (the power company 50).

Second, because the revised PPA may not allow for make-up provisions in the event of force majeure, the reserve account of the SPV 56 may contain sufficient cash for debt service coverage in the event of a prolonged force majeure, such as six months or longer. In that way, the bondholders 62 may be protected against the risk that cash flow to the SPV 56 will be curtailed in situations where force majeure events prevent the SPV 56 from delivering power to the power distributor 52 and, consequently, relieve the power distributor 52 from making payments to the SPV 56. Thus, the reserve account may help to reduce the risk of default of the debt securities.

The power distributor 52 may be any entity that distributes electrical power to consumers, either directly or indirectly. For example, the power distributor 52 may be a government or municipal agency designated to manage the power procurement for a sovereign or governmental entity, such as a state of the United States. According to one embodiment, the power distributor 52 may be the California Department of Water Resources (“CDWR”). The CDWR is a department within the Resource Branch of the Executive Branch of the State of California that was designated in 2001 by Governor Davis to manage the power procurement for all California electric utility plants. In this function, the CDWR entered into a number of long-term power off-take contracts with various entities to secure California's long-term power needs.

As background, throughout the latter half of 2000 and the first half of 2001, the marketplace for electric power in California experienced a period of high volatility and prices. As part of a larger effort by the state of California to stabilize prices, CDWR entered into long-term power purchase contracts with various counter parties. These long-term power purchase contracts (i.e., PPAs) were entered into at prices that were below the then-prevailing market prices in California but were higher than the prices that the California market had historically experienced or experiences now.

CDWR's obligations to make payments under, and any liability of, or judgment against CDWR in connection with the revised PPA may be satisfied from the Electrical Power Fund (“CDWR Fund”), which was established under California law and in which all of CDWR's revenues are held.

In October and November of 2002, CDWR issued, in several series, $11,263,500,000 aggregate principal amount of revenue bonds (“CDWR bonds”). The CDWR bonds are a “special obligation” of the CDWR payable solely out of the CDWR fund and not supported by the full faith and credit or taxing power of the State of California, nor by the other assets of CDWR. The indenture under which the CDWR bonds were issued establishes seven sub-accounts divided into two sets into which the CDWR fund revenues are deposited. One set of these sub-accounts is the “bond charge accounts,” from which debt service on the CDWR bonds is paid. The other set are the “power charge accounts” from which payment of CDWR's other obligations, including payment under CDWR's “priority long-term power contracts” are made. The revised PPA between the SPV 56 and CDWR may be a priority long-term power contract for purposes of the CDWR bond indenture.

Pursuant to the CDWR bond indenture, payments under priority long-term power contracts are first in priority of payment from amounts in the power charge accounts and, if there are insufficient funds in those accounts to make such payments, CDWR is required on a monthly basis to transfer funds from the bond charge accounts to cover any short fall prior to making any other payment (including debt service on the CDWR bonds) from the bond charge accounts.

For an embodiment where the power distributor 52 is CDWR, the power supplier 60 may procure electric energy to be delivered under the mirror PPA from resources available in the California and Wider Western Electricity Coordinating Counsel (“WECC”) markets and potentially from certain power purchase agreements of the power supplier 60, or from the power supplier's own sources of power (e.g., power plants).

All energy scheduled for delivery to CDWR may be scheduled with the California Independent System Operator or successor entity (“CAISO”) by a CAISO-certified scheduling coordinator. In one embodiment, as part of the scheduling services agreement between the SPV 56 and power supplier 60, the power supplier 60 may act as both the CAISO scheduling coordinator for the SPV 56 and the scheduling agent for the SPV 56 to arrange deliveries to the SPV 56 under the mirror PPA and the SPV's deliveries to CDWR under the revised PPA.

In some cases, the original PPA allows the purchaser to terminate the PPA upon non-delivery of power. For example, the original PPA may specify that if 95% or less of the required power was delivered over a specified time window (such as, for example, any two-month period), the PPA may be terminated by the purchaser. In order to monetize such a contract, the mirror PPA may be written to include a liquidated damages clause that covered the potential loss to the investors (e.g., bond holders 62) resulting from termination of the revised PPA by the purchaser. Thus, the bondholders 62 may be protected by the third-party guarantor's guaranty of the payment obligations of the power supplier 60 under the mirror PPA.

Some PPAs include make-up provisions that allow the seller to make up delivery of power in following periods in cases where force majeure prohibits the seller from delivering power according to schedule. In these situations, the flow of cash is made up in subsequent periods when the power is actually delivered, causing a minimal impact to the bondholders aside from some timing risks. According to various embodiments of the present invention, in order to monetize a PPA with no force majeure make-up provisions, the reserve account of the SPV 56 may include enough funds to cover the debt service on the debt securities for a specific time period such as, for example, six months, to cover the possibility of force majeure. Historically, periods of force majeure have been significantly less than six months.

According to other embodiments, the payments for energy and capacity from the buyer (e.g., power distributor 52) to the seller (e.g., SPV 56) may allow for fixed payments of capacity and index-based payments for energy. In this scenario, the capacity payments may continue to be made by the buyer to the seller, while the energy payments may be adjusted periodically according to a defined index. Built into the index-based energy payments may be the value of the differential between the market price of energy and the contract price of energy, which may be captured in the heat rate (which measures the efficiency of a plant in producing electricity from a unit volume of gas) of the physical plant and the implied heat rate for energy. The buyer may take on the energy price risk, which alleviates the need for the seller to enter into hedges to fix the seller's purchase price of energy that it must supply to the buyer. This may result in reduced costs for the seller.

In most PPAs, the scheduling of power is either done by the buyer or the original seller (e.g., the holder of the plant assets in the original PPA). In amending the original PPA to create the revised PPA, according to various embodiments, the scheduling duties may be shifted to the seller (e.g., SPV 56, the power supplier 60 or the administrative agent 64). This may be superior to having either the buyer or the original seller (e.g., the power company 50) perform the scheduling. By having the seller schedule the power, the bondholders 62 may gain more comfort because of the improved coordination between the scheduling with the actual delivery of power.

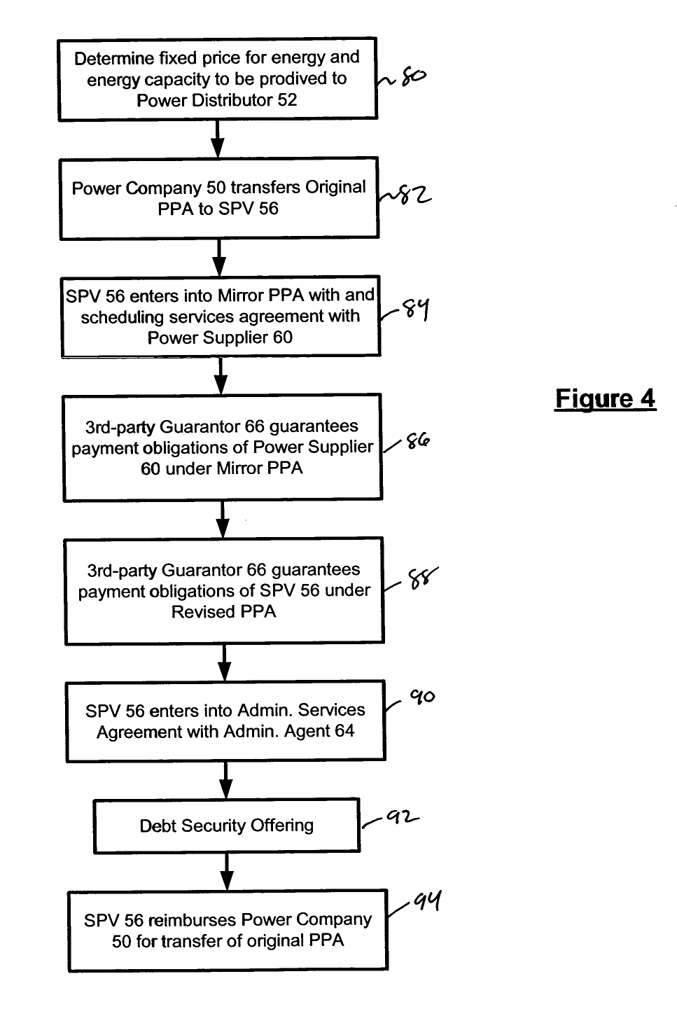

FIG. 4 is a flow chart illustrating the method of monetizing the original PPA according to various embodiments of the present invention. At step 80, because only fixed—as opposed to variable—prices may be monetized, a fixed price for the energy and energy capacity to be delivered under the original PPA may be determined. The revised PPA may contain fixed payments that are derived from the fixed payments in the original PPA. These payments may reflect a discount offering to the power distributor 52 in exchange for the right to restructure the original PPA. If the power company 50 or the SPV 56 wants to monetize a floating payment from the power distributor 52, the revised PPA may be based on a relevant market index plus a mutually agreed-upon spread. The spread (or margin) may then be monetized. According to other embodiments of the present invention, only a fixed portion of the energy and energy capacity payments under the original PPA may be monetized, leaving a variable portion of the price not monetized.

At step 82, the power company 50 may transfer the original PPA to the SPV 56. The original PPA 56 may then be revised (i.e., the “revised PPA”) to specify that the SPV 56 can provide the energy and energy capacity from any source other than just the qualifying facility 54. If the original PPA does not allow the original PPA to be transferred to the SPV 56, the power company 50 and the power distributor 52 may amend the original PPA prior to transfer to the SPV 56 to permit the novation.

At step 84, the SPV 56 may enter into the mirror PPA with the power supplier 60. As discussed previously, terms of the mirror PPA may match or be substantially similar to terms of the revised PPA. For example, the quantity of energy and energy capacity, the delivery schedules, the term and the penalties for breach may be the same for both the revised and mirror PPA. The price for the energy and energy capacity, however, would be lower in the mirror PPA than in the revised PPA such that the SPV 56 will realize a price spread, as described previously. In addition, the SPV 56 and the power supplier 60 may enter into a scheduling services agreement that stipulates the energy and energy capacity delivery schedules, as described previously.

At step 86, the SPV 56 and the third-party guarantor 66 may guarantee to the SPV 56 the payment obligations of the power supplier 60 under, for example, the mirror PPA and/or the scheduling services agreement, which may include, for example, any obligation of the power supplier 60 to pay damages or make termination or indemnity payments to the SPV 56 if the power supplier 60 fails to perform any of its obligations under the mirror PPA or the scheduling services agreement.

At step 88, the third-party guarantor 66 may guarantee to the power distributor 52 to payment obligations of the SPV 56 under the revised PPA, whereby the third-party guarantor 66 guarantees, for example, up to a maximum liability limitation amount, the payment of all of the SPV's payment obligations under the revised PPA to the power distributor 52, which may include any obligation of the SPV 56 to pay damages or make termination or indemnity payments to the power distributor if the SPV 56 fails to perform any of its obligations under the revised PPA.

At step 90, the SPV 56 may enter into the administrative services agreement with the administrative agent 64. As described previously, under the administrative services agreement the administrative agent 64 may administer and perform all of the SPV's administrative obligations under the revised PPA (other than scheduling electrical energy to be delivered to the power distributor 52 and certain related services, which may be the responsibility of the power supplier 60 under the scheduling services agreement), exercise on behalf of the SPV 56 all of the SPV's rights under the mirror PPA and coordinate operations of the SPV 56 under both the revised PPA and the mirror PPA. In addition, the administrative agent 64 may administer and perform all of the SPV's administrative obligations under other material agreements of the SPV 56, the indenture and other financial documents.

At step 92, the SPV 56 may issue debt securities (e.g., notes or bonds) to the bondholders 62. According to various embodiments, the debt securities may be senior secured notes offered in, for example, the Rule 144A/Reg. S market. The term of the debt securities may equal the term of the revised and mirror PPAs. The debt service for the debt securities may be financed by the excess cash that the collections account of the SPV 56 has left over after every period of the revised PPA (arising out of the above-described price difference between the revised PPA and the mirror PPA). At step 94, the SPV 56 reimburses the power company 50 for transfer of the PPA to the SPV 56 with proceeds generated from the debt security offering at step 92.

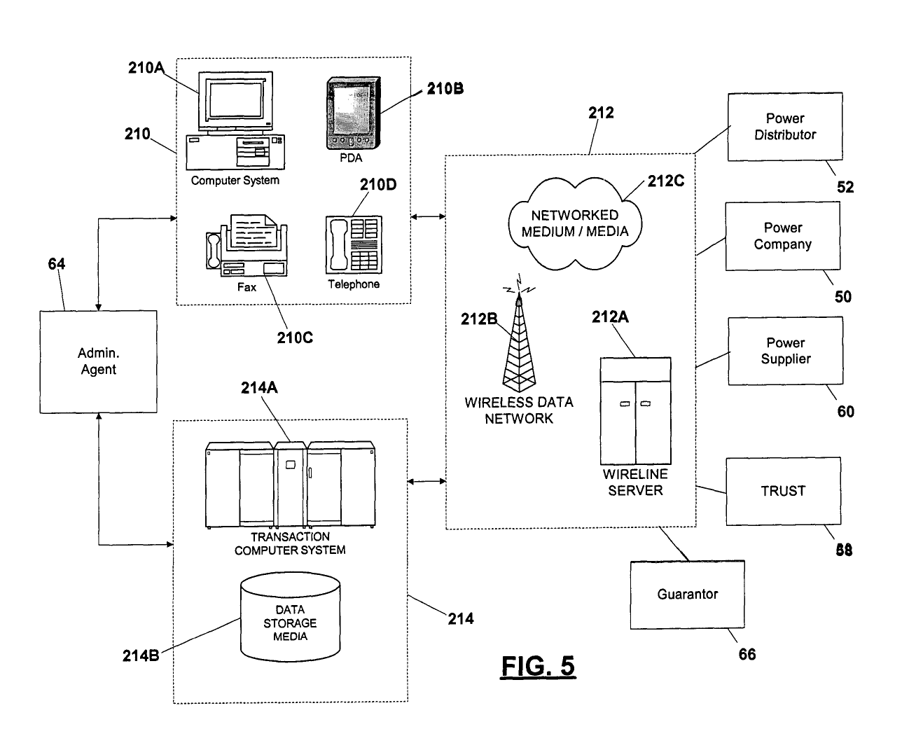

FIG. 5 illustrates a system for practicing the above-described methods according to various embodiments. As shown in FIG. 5, the administrative agent 64, for example, can communicate and/or exchange data with one or more of the power distributor 52, the power company 50, the power supplier 60, the administrative agent 64, the trust 58 and the third-party guarantor 66 regarding, for example, the business of the SPV 56. For example, the administrative agent 54 may communicate with the power supplier 60 and the power distributor 52 regarding the delivery of energy. In addition, the administrative agent 64 may facilitate communication between the trust 58, the power distributor 52 and the power supplier regarding the payment of revenue for the power supplied under the revised and mirror PPAs.

In one aspect, the administrative agent 64 can be operatively associated with one or more communications devices 210 such as, for example and without limitation, a computer system 210A, a personal digital assistant 210B, a fax machine 210C, and/or a telephone 210D (e.g., a wireline telephone, a wireless telephone, a pager, and the like), and/or other like communication devices. The communication devices 210 permit the administrative agent 64, the power distributor 52, the power company 50, the power supplier 60, the trust 58 and the third-party guarantor 66 to communicate between/among each other through one or more communication media 212, such as by use of electronic mail communication through one or more computer systems, for example. The communication media 212 can include, for example and without limitation, wireline communication means such as a wireline server 212A, a wireless data network 212B, and/or a connection through a networked medium or media 212C (e.g., the Internet). Similarly, although not shown in FIG. 5 for purposes of simplicity, each of the power distributor 52, the power company 50, the power supplier 60, the trust 58 and the third-party guarantor 66 may have associated communication devices 210 in order to communicate via the communication media 212.

In addition, as shown in FIG. 5, the administrative agent 64 may have an associated computer system 214 including a transaction computer system 214A and data storage media 214B for facilitating performance of the tasks described herein of the administrative agent 64. Similarly, although not shown in FIG. 5 for purposes of simplicity, the each of the power distributor 52, the power company 50, the power supplier 60, the trust 58 and the third-party guarantor 66 may have an associated computer system 214 for facilitating performance of their respective functions as described herein.

As used herein, a “computer” or “computer system” may be, for example and without limitation, either alone or in combination, a personal computer (PC), server-based computer, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other like computer-readable media.

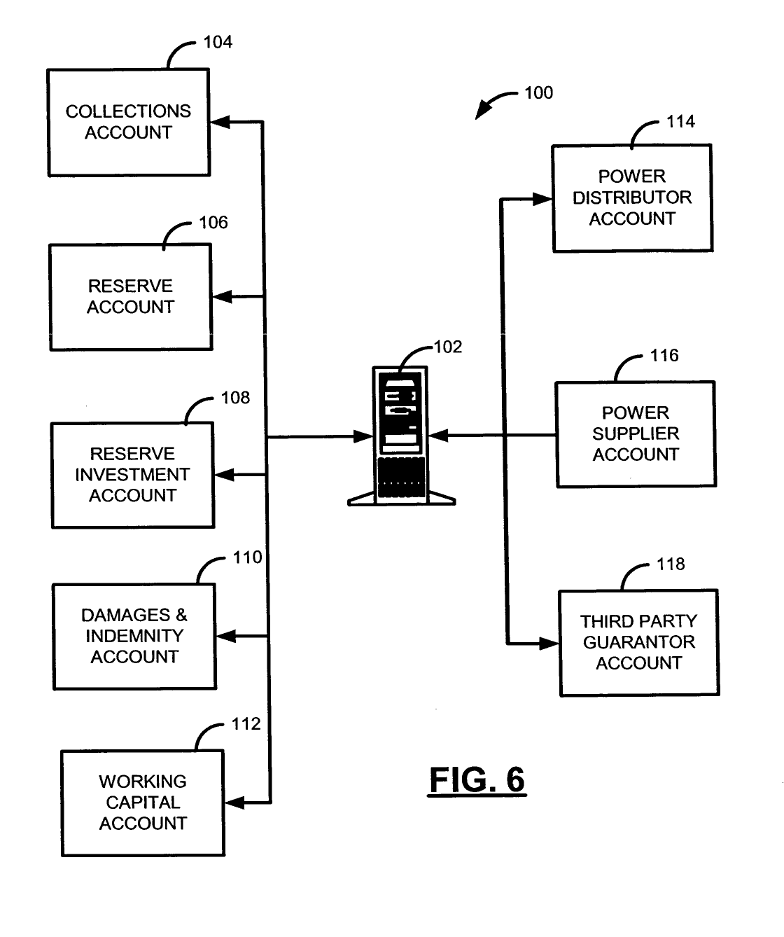

FIG. 6 is a diagram of a system 100 according to various embodiments of the present invention. As illustrated in FIG. 6, the system 100 may include a computer system 102. The computer system 102 may be used to electronically transfer funds from the accounts of the SPV 56, such as, for example, the collections account 102, the reserve account 106, the reserve investment account 108, the damages and indemnity account 110, and the working capital account 112, to other accounts, such as, for example, an account 114 of the power distributor 52, an account 116 of the power supplier 116, and an account 118 of the third party guarantor 66. In FIG. 6, the computer device 102 is shown as a single unit for purposes of convenience, but it should be recognized that the computer device 102 may comprise a number of distributed or networked computing devices, inside and/or outside the same administrative domain. In order to electronically deposit funds in the various accounts, the computer device 102 may execute a series of instructions. The instructions may be software code to be executed by the computer device 102. The software code may be stored as a series of instructions or commands on a computer readable medium, such as a random access memory (RAM), a read only memory (ROM), a magnetic medium such as a hard-drive or a floppy disk, or an optical medium such as a CD-ROM, and may be written in any suitable computer language such as, for example, Java, C, or C++ using, for example, conventional or object-oriented techniques

The preceding description of the monetization method has been provided in the context of monetizing a contract to supply electrical power and/or capacity. The monetization methods of the present invention, however, according to various embodiments, may be employed to monetize a contract to supply other types of commodities besides electrical power. The preceding description in the context of electrical power should be considered illustrative of the scope of present invention and not as limiting.

Furthermore, while several embodiments of the invention have been described, it should be apparent, however, that various modifications, alterations and adaptations to those embodiments may occur to persons skilled in the art with the attainment of some or all of the advantages of the present invention. For example, the steps illustrated in FIG. 4 may be performed in various orders. It is therefore intended to cover all such modifications, alterations and adaptations without departing from the scope and spirit of the present invention as defined by the appended claims.

What is claimed is:

1. A method of monetizing a first contract to supply a commodity from a supplier to a recipient, comprising:
transferring the first contract to a first entity;
revising the first contract such that the first entity may provide the commodity to the recipient from sources other than specified in the first contract;
establishing a second contract to supply the commodity from a second entity to the first entity, wherein the price of the commodity in the second contract is less than the price of the commodity in the revised first contract; and
guaranteeing, by a third-party guarantor, payment obligations of the first entity to the recipient arising out of the revised first contract.

2. The method of claim 1, wherein the third-party guarantor's guaranty of the payment obligations of the first entity is capped by a maximum liability limitation amount.

3. The method of claim 1, wherein the first entity is owned by the supplier.

4. The method of claim 1, further comprising:
offering debt securities from the first entity; and
paying, from the first entity to the supplier, with proceeds from the offering.

5. The method of claim 4, further comprising paying principal and interest on the debt securities from the first entity to holders of the debt securities.

6. The method of claim 5, wherein a debt service coverage ratio of the debt securities is between 1.00 and 1.01.

7. The method of claim 5, further comprising sufficiently funding a reserve account of the first entity such that the first entity can pay the principal and interest on the debt securities in the event of a force majeure of at least six months.

8. The method of claim 5, further comprising establishing an administrative services agreement between the first entity and an administrative agent.

9. The method of claim 5, further comprising establishing the first entity as a subsidiary of the supplier.

10. The method of claim 9, wherein the second entity is a subsidiary of the third-party guarantor.

11. The method of claim 4, wherein the debt securities include senior secured notes.

12. The method of claim 4, wherein the debt securities include subordinated notes.

13. The method of claim 1, further comprising the third-party guarantor guarantying payment obligations of the second entity to the first entity arising out of the second contract.

14. The method of claim 1, wherein revising the first contract includes revising the first contract such that the revised first contract obligates the recipient to pay a fixed price for to the first entity for capacity to supply the commodity and obligates the recipient to pay an index-based price for the commodity.

15. A method of monetizing a first contract to supply power from a qualifying facility owned by a first power company to a power distributor, comprising:
transferring the first contract from the power company to a first business entity;
revising the first contract such that the first business entity may provide power to the power distributor from sources other than the qualifying facility;
establishing a second contract to supply power between a power supplier and the first business entity; and
guaranteeing, by a third-party guarantor, payment obligations of the of the first business entity to the power distributor arising out of the revised first contract.

16. The method of claim 15, wherein quantity and capacity terms of the second contract are similar to the revised first contract.

17. The method of claim 15, wherein the third-party guarantor's guaranty of the payment obligations of the first entity is capped by a maximum liability limitation amount.

18. The method of claim 15, wherein the first business entity is owned by the power company.

19. The method of claim 15, further comprising:
offering debt securities by the first business entity; and
paying, by the first business entity to the power company, for transfer of the first contract with proceeds from the offering of the debt securities.

20. The method of claim 19, wherein the debt securities include senior secured notes.

21. The method of claim 19, wherein the debt securities include subordinated notes.

22. The method of claim 19, further comprising paying to holders of the debt securities principal and interest on the debt securities from the first business entity with from proceeds from the first revised contract.

23. The method of claim 22, wherein a debt service coverage ratio of the debt securities is between 1.00 and 1.01.

24. The method of claim 22, further comprising establishing an administrative services agreement between the first business entity and an administrative agent.

25. The method of claim 22, further comprising sufficiently funding a reserve account of the first entity such that the first entity can pay the principal and interest on the debt securities in the event of a force majeure of at least six months.

26. The method of claim 22, wherein the power distributor is a government agency for managing the power procurement for a governmental entity.

27. The method of claim 26, further comprising the power distributor offering debt securities, wherein the power distributor is obligated to pay the first business entity for power under the revised first contract prior to servicing the debt securities offered by the power distributor.

28. The method of claim 26, wherein the power distributor is obligated to pay the first business entity for power under the revised first contract prior to servicing the debt securities offered by the power distributor.

29. The method of claim 26, wherein the power distributor is a government agency for managing the power procurement for a state of the United States.

30. The method of claim 29, wherein the power distributor is the California Department of Water Resources.

31. The method of claim 22, further comprising establishing the first business entity as a subsidiary of the power company.

32. The method of claim 31, wherein the power supplier is a subsidiary of the third-party guarantor.

33. The method of claim 22, wherein the price for the power under the revised first contract is greater than the price for the power under the second contract.

34. The method of claim 33, wherein paying the principal and interest on the debt securities includes paying the principal and interest on the debt securities from excess revenue of the first business entity due to the price difference of the power between the revised first contract and the second contract.

35. The method of claim 15, further comprising the third-party guarantor guarantying payment obligations of the power supplier to the first entity arising out of the second contract.

36. The method of claim 15, wherein revising the first contract includes revising the first contract such that the revised first contract obligates the power distributor to pay a fixed price for to the first entity for capacity to supply the power and obligates the recipient to pay an index-based price for the power.

37. The method of claim 15, wherein establishing the second contract includes providing a liquidated damages clause in the second contract obligating the power supplier to pay liquidated damages to the first entity under certain specified conditions in the second contract, and further comprising a third-party guarantor guarantying payment obligations of the power supplier under the second contract, including the liquidated damages.

38. A method of monetizing a first contract to supply power from a qualifying facility owned by a first power company to a power distributor, comprising:
transferring the first contract from the power company to a first business entity;
revising the first contract such that the first business entity may provide power to the power distributor from sources other than the qualifying facility and such that the revised first contract obligates the power distributor to pay a fixed price for to the first entity for capacity to supply the power and obligates the recipient to pay an index-based price for the power;
establishing a second contract to supply power between a power supplier and the first business entity, wherein the quantity and capacity terms of the second contract are similar to the revised first contract.

39. The method of claim 38, wherein the price for the power under the revised first contract is greater than the price for the power under the second contract.

40. The method of claim 39, further comprising:
offering debt securities by the first business entity; and
paying, by the first business entity to the power company, for transfer of the first contract with proceeds from the offering of the debt securities.

41. The method of claim 40, wherein the debt securities include senior secured notes.

42. The method of claim 40, wherein the debt securities include subordinated notes.

43. The method of claim 38, wherein the first business entity is owned by the power company.

44. The method of claim 40, further comprising sufficiently finding a reserve account of the first entity such that the first entity can pay the principal and interest on the debt securities in the event of a force majeure of at least six months.

45. The method of claim 38, wherein the power distributor is obligated to pay the first business entity for power under the revised first contract prior to servicing debt securities offered by the power distributor.

46. The method of claim 40, further comprising a third-party guarantor guarantying payment obligations of the power supplier to the first entity arising out of the second contract.

47. The method of claim 38, wherein establishing the second contract includes providing a liquidated damages clause in the second contract obligating the power supplier to pay liquidated damages to the first entity under certain specified conditions in the second contract, and further comprising a third-party guarantor guarantying payment obligations of the power supplier under the second contract, including the liquidated damages.

48. A method of monetizing a first contract to supply power from a qualifying facility owned by a first power company to a power distributor, comprising:
transferring the first contract from the power company to a first business entity;
revising the first contract such that the first business entity may provide power to the power distributor from sources other than the qualifying facility;
establishing a second contract to supply power between a power supplier and the first business entity, wherein the quantity and capacity terms of the second contract are similar to the revised first contract;
offering debt securities by the first business entity;
paying, by the first business entity to the power company, for transfer of the first contract with proceeds from the offering of the debt securities; and
sufficiently funding a reserve account of the first entity such that the first entity can pay the principal and interest on the debt securities in the event of a force majeure of at least six months.

49. The method of claim 48, wherein the debt securities include senior secured notes.

50. The method of claim 48, wherein the debt securities include subordinated notes.

51. The method of claim 48, wherein establishing the second contract includes providing a liquidated damages clause in the second contract obligating the power supplier to pay liquidated damages to the first entity under certain specified conditions in the second contract, and further comprising a third-party guarantor guarantying payment obligations of the power supplier under the second contract, including the liquidated damages.

52. A method, comprising:
determining a prospective price of energy and energy capacity to be supplied from a qualifying facility to a power distributor under a first contract between a power company that owns the qualifying facility and the power distributor;
transferring the first contract from the power company to a first business entity;
revising the first contract such that the first business entity may provide energy and energy capacity to the power distributor from sources other than the qualifying facility and such that the power distributor is to pay the first business entity the prospective price for the energy and energy capacity supplied to the power distributor by the first business entity under the revised first contract;
establishing a second contract to supply power between a power supplier and the first business entity;
monetizing a difference between the price of the energy and energy capacity of the second contract and the determined prospective price of the energy and energy capacity of the revised first contract.

53. The method of claim 52, further comprising guaranteeing, by a third-party guarantor, payment obligations of the of the first business entity to the power distributor arising out of the revised first contract.

54. The method of claim 52, wherein:
determining the prospective price includes determining a prospective fixed price component and variable price component;
revising the first contract includes revising the first contract such that the power distributor is to pay the first business entity the prospective fixed price component and the variable price component for the energy and energy capacity supplied to the power distributor by the first business entity under the revised first contract; and
monetizing the difference includes monetizing the difference between the price of the energy and energy capacity of the second contract and only the determined prospective fixed price component of the revised first contract.

55. A method, comprising:
transferring a first contract from a power company to a first business entity, wherein the first contract obligates the power company to supply power from a qualifying facility owned by the power company to a power distributor;
revising the first contract such that the first business entity may provide power to the power distributor from sources other than the qualifying facility, and such that the power distributor is obligated to pay the first business entity an index-based price plus a margin for power supplied under the revised first contract to the power distributor;
establishing a second contract to supply power between a power supplier and the first business entity; and
monetizing the margin.

56. The method of claim 55, wherein monetizing the margin includes:
offering debt securities by the first business entity; and
paying, by the first business entity to the power company, for transfer of the first contract with proceeds from the offering of the debt securities.

57. The method of claim 55, further comprising a third party guarantor guarantying payment obligations of the first business entity under the revised first contract.

58. The method of claim 57, further comprising the third party guarantor guarantying payment obligations of the power supplier under the second contract.

59. A method, comprising:
transferring a first contract from a power company to a first business entity, wherein the first contract obligates the power company to supply power from a qualifying facility owned by the power company to a power distributor, and wherein the first contract allows the power distributor to terminate the first contract if less than a threshold amount of the required power under the first contract is not supplied within a specified time frame;
revising the first contract such that the first business entity may provide power to the power distributor from sources other than the qualifying facility; and
establishing a second contract to supply power between a power supplier and the first business entity, wherein the second contract obligates the power supplier to pay liquidated damages when the threshold amount of required power is not supplied by the power supplier over the specified time frame.

60. The method of claim 59, further comprising:
offering debt securities by the first business entity; and
paying, by the first business entity to the power company, for transfer of the first contract with proceeds from the offering of the debt securities.

61. The method of claim 59, further comprising a third party guarantor guarantying payment obligations of the first business entity under the revised first contract.

62. The method of claim 61, further comprising the third party guarantor guarantying payment obligations of the power supplier under the second contract.

63. A method, comprising:
transferring a first contract from a power company to a first business entity, wherein the first contract obligates the power company to supply power from a qualifying facility owned by the power company to a power distributor, and wherein the first contract contains no force majeure makeup provisions;
revising the first contract such that the first business entity may provide power to the power distributor from sources other than the qualifying facility;
establishing a second contract to supply power between a power supplier and the first business entity;
offering debt securities by the first business entity;
paying, by the first business entity to the power company, for transfer of the first contract with proceeds from the offering of the debt securities; and
sufficiently funding a reserve account of the first business entity to include funds to cover the debt service on the debt securities for a predetermined time period.

64. The method of claim 63, wherein the predetermined time period is at least six months.

65. The method of claim 63, further comprising a third party guarantor guarantying payment obligations of the first business entity under the revised first contract.

66. The method of claim 65, further comprising the third party guarantor guarantying payment obligations of the power supplier under the second contract.
